(19) United States
(12) Patent Application Publication
(10) Pub. No.: US 2013/0331086 A1
(43) Pub. Date: Dec. 12, 2013

(54) PORTABLE ELECTRONIC DEVICE CONTROL OF OTHER ELECTRONIC DEVICES

(71) Applicant: David Pearson, Romeo, MI (US)

(72) Inventor: David Pearson, Romeo, MI (US)

(73) Assignee: TMW Enterprises, Inc., Troy, MI (US)

(21) Appl. No.: 13/489,759

(22) Filed: Jun. 6, 2012

(51) Int. Cl. G08C 23/02

(52) U.S. Cl. 455/420

(57) ABSTRACT

A smartphone or other portable electronic device is used to control another electronic device using the existing audio output of the phone without modification. The audio link can be ultra-sonic, sub-sonic, or audible and, if the controlled device has an audio output, bi-directional communications may be achieved using the microphone of the smartphone. The smartphone acts as a control panel to program or operate the external device. In one disclosed example, the smartphone is used to control and tune a portable sports event radio using an acoustic link and tone pattern(s).

### FIELD OF THE INVENTION

This invention relates generally to portable electronic devices and, in particular, to the use of a smartphone or other portable electronic device to program, tune and/or control another device.

### BACKGROUND OF THE INVENTION

As cell phones have evolved into smartphones, the devices have taken on a wide range of applications and uses. One area where smartphones are deficient is in the control of other electronic devices. For example, while a smartphone may be used as a remote control transmitter, an external add-on device must be provided to transmit the requisite infrared (IR) signals. For most smartphone universal remotes, such devices are provided in the form of a “dongle” that connects to the phone. The main drawback of this approach is that most dongle-based IR emitters are proprietary to a particular app. Some apps forgo dongles, using external boxes for control instead. The phone communicates with the box via Bluetooth or other wireless protocols as available. While this arrangement does not require the user to attach a gizmo to their phone, the downside is the requirement of a specific hardware box.

It would therefore be advantageous to enable a smartphone to control a different device without the use of external hardware, relying instead on the available outputs of the smartphone without modification.

### SUMMARY OF THE INVENTION

This invention resides in the use of a portable electronic device to control another electronic device using the existing audio output of the portable device without modification. In the preferred embodiment, the portable electronic device is a smartphone, though other device with audio outputs may be used, including palmtops, tablets, and laptop computers. The audio link can be ultra-sonic, sub-sonic, or audible and, if the controlled device has an audio output, bi-directional communications may be achieved using the microphone of the smartphone.

In the preferred embodiments, the smartphone acts as a control panel to program or operate the external device. In one disclosed example, the smartphone is used to control and tune a portable radio using an acoustic link.

### BRIEF DESCRIPTION OF THE DRAWINGS

FIG. 1 is a simplified drawing showing how a smartphone can act as the control panel for a portable radio receiver;

FIG. 2 is a block diagram illustrating bidirectional communications with a different device using a smartphone;

FIG. 3 is a block diagram of one way to decode an FSK modulated control signal;

FIG. 4 is an example of a data packet; and

FIG. 5 is a block diagram of a protocol converter constructed in accordance with the invention.

### DETAILED DESCRIPTION OF THE INVENTION

This invention resides in the use of a portable electronic device to control another electronic device using the existing audio output of the portable device without modification. In the preferred embodiment, the portable electronic device is a smartphone, though other device with audio outputs may be used. As such, in this disclosure, “smartphone” should be taken to mean any portable electronic device having an audio output including, but not limited to palmtops, tablets, laptops and conventional cell phones. The audio link can be ultra-sonic, sub-sonic, or audible and, if the controlled device has an audio output, bi-directional communications may be achieved using the microphone of the smartphone.

One example provides a method for tuning and/or enabling features on a radio receiver, including ear-mounted and handheld radio receivers. An existing sports event radio uses two push buttons to change bands and change the receive frequency. Two or three bands are available, FM/AM broadcast and up to 8 channels of event broadcasts which are typically transmitted on the vacant VHF TV channels. To tune in a station on the FM or AM band, either the up or down button will enable scanning for the next broadcast station, tuning up or down depending on which button is pressed. Pressing and holding both buttons will switch from FM broadcast to Event radio and back again. When in the Event radio band, the up and down buttons will scroll up and down the event channels after each button press. For example when tuned to E1 (event channel 1) the pressing the up button will move to E2 then E3 E7 then E1, likewise the down button will move backward, E3 to E2 to E1 to E7. The frequencies of the radio station, AM or FM or the event channel number are displayed on a small radio mounted LCD display.

Currently each radio is programmed with the event frequencies unique to the event the where radio is being sold. Frequencies are different due to FCC license requirements, preventing interference with other broadcasts. These frequencies are stored in an EEPROM inside the event radio. For example, at one event, E1 is 62.5 MHz, E2 is 65.7 MHz; at a different event, E1 is 67.4 MHz and E2 is 66.6 MHz. Each radio is programmed with these frequencies upon receipt from the manufacturer and prior to distribution to the stadium. As such, radios programmed for one event cannot be reused at other events unless they are programmed with new frequencies at the stadium. This is labor intensive and inconvenient.

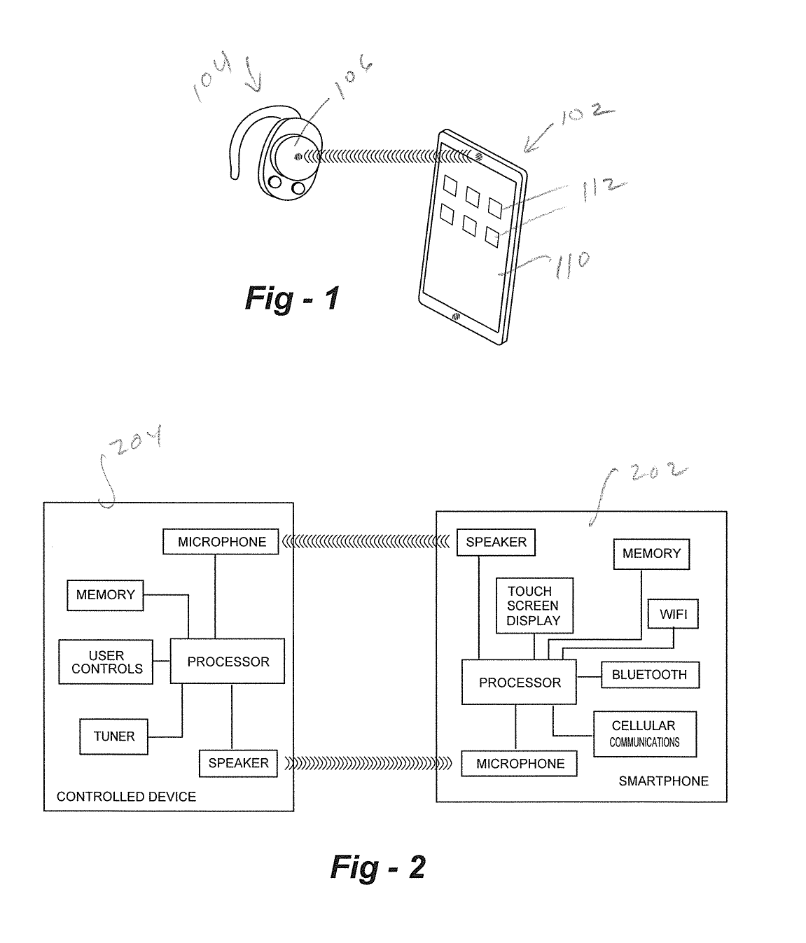

In order to reduce costs of the event radio, integrate smartphone advertising with the event radio experience, and enable restricted or paid content, this invention uses a smartphone as the event radio's control panel using a wireless link. The audio link can be ultra-sonic, sub-sonic or audible. FIG. 1 is a simplified drawing showing how a smartphone 102 can act as the control panel for a portable radio receiver 104 such as the event radio. The radio 104 in this case is equipped with a microphone 106 enabling the radio 104 to receive audio tones from the phone 102. Given the appropriate application (app) on the phone 102, the touch-screen display 110 includes one or more soft buttons 112 used to control the device 104.

In accordance with the invention, the radio can operate in two modes: In the open mode, the radio will receive an event channel pre-programmed into the radio which has unrestricted access and is the default when the radio is turned on. In the second, smartphone controlled mode, the radio will respond to frequency changes transmitted via the ultra-sonic audio control link from the smartphone. This link will enable the reception of any frequency the smartphone commands.

In the smartphone controlled mode, the smartphone may learn the event radio to allow exclusive control of the event radio by the smartphone. A modified learning mode would allow a single smartphone to learn multiple radios. The learn process would proceed as follows: The user would start the event radio application app on the smartphone. The app would prompt the user to place the earpiece of the event radio near the smartphone's microphone. The app would prompt the user to turn on the event radio. Each time the radio is turned on, the event radio will transmit using its speaker or earphone, a burst of FSK, AM or other modulated tone, serial digital signal that is the serial number of the radio. The smartphone will store this and notify the user that the event radio ID was learned by the smartphone. Alternatively, the smartphone can send an audio signal to the event radio telling it to transmit its serial number.

Once the smartphone has recognized the event radio, the smartphone may send commands to change frequency, mute, or control volume of the event radio via the audio link. These commands are preferably serial digital encoded audio bursts from the smartphones speaker and/or earphone. They are modulated in a manner similar to the serial number sent from the event radio to the smartphone, and are received by a microphone in the event radio.

On the smartphone, once the event radio has been learned, an app can now control the frequency of the event radio, becoming the event radio's control panel showing its frequency. FIG. 2 is a block diagram illustrating bidirectional communications with a device 204 using a smartphone 202. If the device 204 includes a speaker or headset, as would be the case with the event radio, bidirectional communications are made possible, as shown. Since the audio control link can be bi-directional as well, the smartphone can also recognize the frequency of the event radio.

Continuing the reference to FIG. 2, the app may be loaded through a WiFi, Bluetooth, cellular or other connection. Moreover, the audio received from the controlled device may direct the phone to obtain the appropriate app. Once loaded, the app may record that the radio was tuned to a particular channel or a survey button may instead be used. Given that the device 104, 204 is capable of receiving audio/acoustic commands, tone patterns may be received from sources other than the smartphone. For example, externally broadcast SCA, RDS, or RF signals may cause the device to temporarily receive an emergency broadcast, for example. Indeed, all user channels may be changed simultaneously by sending a control tone through a public address system, for example. This would enable reception of emergency or public service announcements, and so on, by all radio listeners. Additionally, the radio frequencies themselves could be programmed into the radio over the public address system with pairing occurring later. PA system programming would eliminate the need for factory programming of the pre-programmed unrestricted access main event channel for use by non “smart” device equipped users. Another advantage of the invention, particularly with regard to the application, is reducing waste from disposed radios by making the radios usable at future events.

The smartphone app, if written to deliver targeted advertising to the event radio user, will work as follows: when unpaired the event radio will only receive the single general broadcast. Once paired, the app will have soft buttons, that when pressed, will give the user advertisements or other content, and then tune the radio to the event channel indicated by that button. The app can have multiple soft buttons, with multiple advertisements, controlling multiple channels. A home button on the app will return the event radio to the general broadcast. For AM or FM reception, the app will have an up/down tuning soft button and may have advertising linked FM or AM presets similar to the event frequencies.

The event radio will only tune to frequencies that the smartphone app sends via the audio control link. This will allow smartphone apps to enable pay per listen use of the event radio. If an app is launched which requires payment for an event broadcast, and payment for an event made, this will enable the control button app which will send the frequency infoiination to the event radio. In this mode the audio data sent to the event radio will be encrypted with the serial number received by the smartphone from the event radio. This will ensure only one radio will be enabled for one subscription or pay to listen.

The app may further send an automatic text message or store the event radio channel usage data for later retrieval by a phone call or data connection. This would be used for further promotional use and advertisement effectiveness tracking.

Note that if the user does not have a smartphone, local programming Kiosks could be setup to allow the user to change his radio to the desired channel using a Kiosk audio link. These Kiosks would have advertising banners, etc. to attract and communicate to the event radio user.

In terms of Hardware Requirements, the current event radio tunes a frequency using a PLL synthesized receiver controlled by a microcontroller. Receiver frequencies for an event are programmed into an EEPROM prior to distribution to the stadium and are usually different for each location. Event channel, band switch and tuning are controlled by a pair of push buttons, one up, one down. Frequency or event channel are displayed on a radio mounted LCD. The smartphone controlled event radio will not need the LCD or the push buttons, as these functions are done on the smartphone screen.

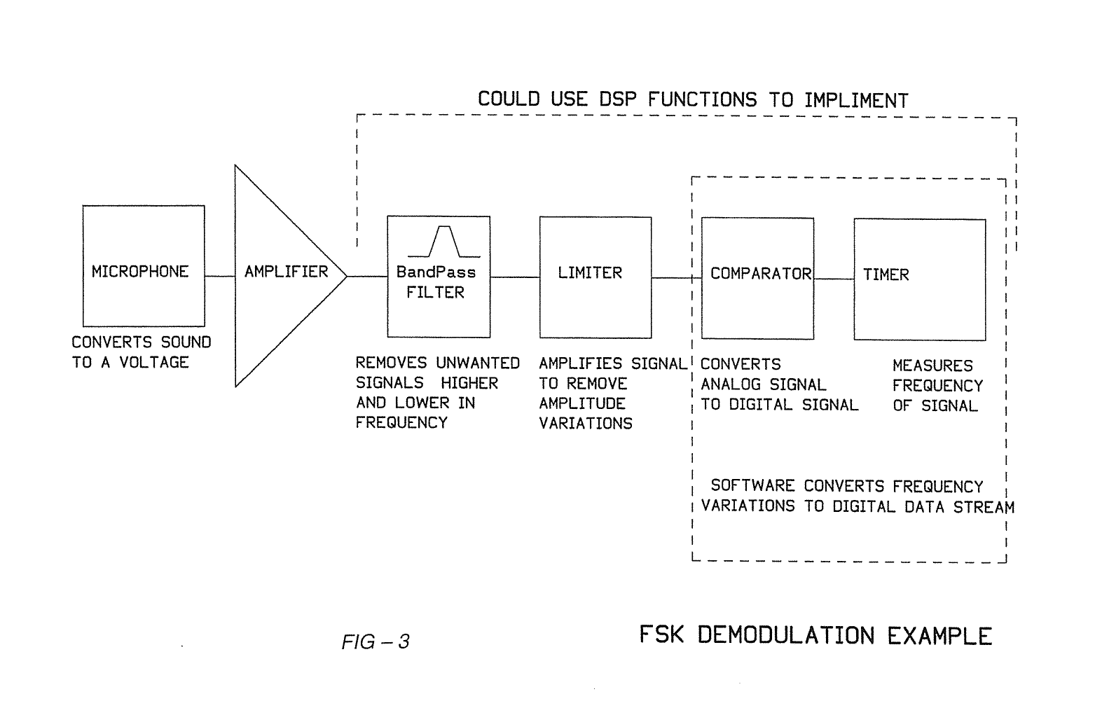

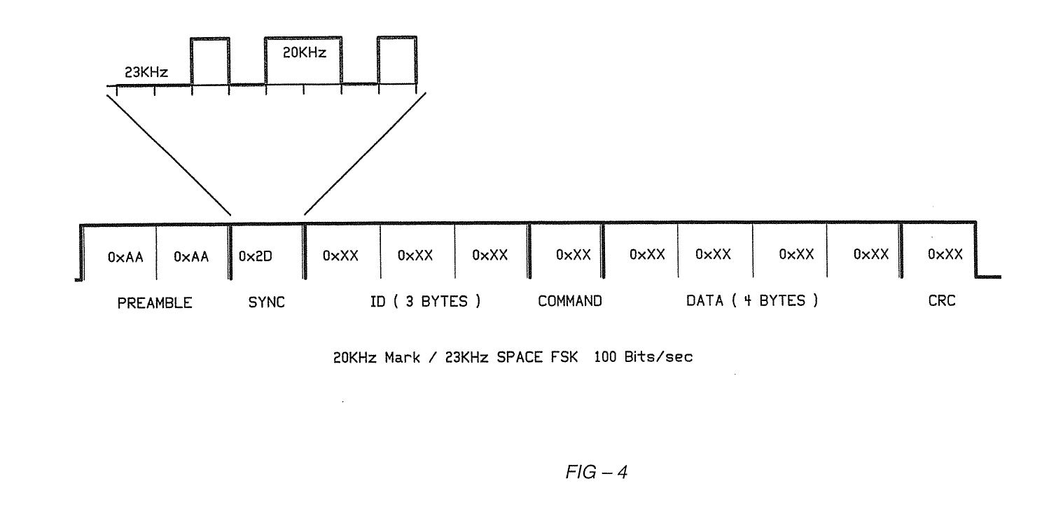

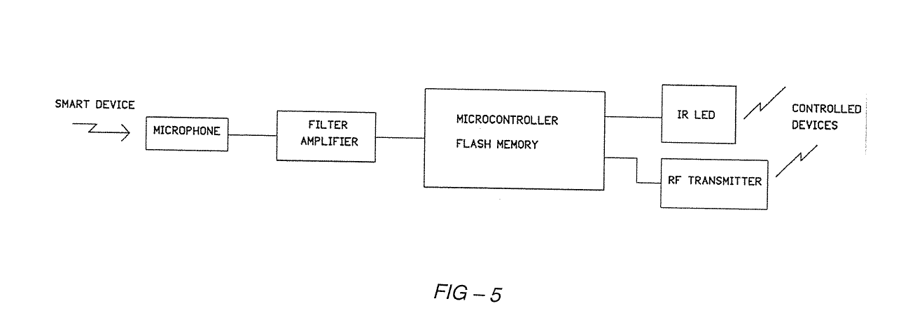

A microphone is added to the event radio to receive the audio control signals from the smartphone. These control signals are FSK or AM, etc. modulated serial digital data bursts that are received by the microphone, amplified, and processed by the microcontroller into useful control data. FIG. 3 is a block diagram of one way to decode the signal, and FIG. 4 is an example of a data packet. The control signals are only transmitted by the smartphone when action is required in the event radio, i.e., tuning or reading frequency or changing volume. The event radio is always monitoring the audio signal for a valid control burst in a low power sleep mode. During this sleep mode, only the audio amplifier and wakeup circuits on the microcontroller are on.

Transmissions to the smartphone from the event radio use the speaker or earphone as the output device. The digital control signal output from the microcontroller will be mixed with the audio output and sent the audio amplifier. The more general use of this transmission path are for learn mode only and most likely the bidirectional features may not be used.

In addition to acoustic communication, the invention does not preclude the use of infrared or RF should such technologies become available.

### Additional Enhancements

### Control of Many Devices Over a Large Area

If a public address system were used to broadcast the control tones, radios or devices could be controlled in unison to change to an emergency station, or mute. Further control could return the radio to its previous station and state. These control signals could be used wherever large numbers of people congregate or traverse.

### Receiver Demodulation Hardware/Software

The smartphone would transmit control tones using either FSK modulation or OOK modulation of either a sub audible or ultra-sonic carrier. A microphone or ear-radio speaker will receive the audio control tones riding on background noise. The low level signal from the microphone will be amplified by an amplifier as well as high or low pass filtered, depending on the tone frequency, sub-audible or ultrasonic. This signal will connect to either an Analog to Digital converter or a zero-crossing detector or analog comparator, usually contained in the microcontroller. Using digital signal processing techniques, the signal will be decomposed until a frequency discrimination is made, using an FFT algorithm or similar. Changes in this output related to frequency shift or frequency amplitude will constitute the reconstructed control signal. The microcontroller will then use this serial data stream to store a transmitted control word in memory, which will initiate certain functions in the radio or device.

### Protocol Conversion

A separate protocol converter box may be used to convert acoustic signals using the audio transmission protocol from the smartphone, tablet, etc. to Infrared, RF, or network IP signals transmitting protocols that chosen devices can understand. For example, when the converter box is programmed to a TV or a cable box, the converter box would take an acoustic channel “up” command and translate the command using a microcontroller to drive a Infrared LED that would transmit channel “up” command using the proper protocol for the TV. The protocol converter could also use input from IR, RF, or wireless network IP instead of acoustic.

FIG. 5 is a block diagram of a protocol converter constructed in accordance with the invention. The controlled devices (TV, Cable Box, etc.) model number would be entered into the app running on the smart device (smartphone, tablet, etc.). The app would then query a database that would setup the app with the proper control icons for the selected device. The protocol translation trigger command and protocol response would be transmitted acoustically, (one time, during setup) to the protocol converter box, where they would be stored in Flash memory. These translation pairs would come from information extracted from the database queried by the smart device. For example, an acoustic command 01 (TV Channel UP) would result in a TV Infrared output of 123 in Sony Format.

1. A method of controlling an electronic device with a portable device having an audio output, the method comprising the steps of:
providing an electronic device having a microphone, a controller, and electronic circuitry to be controlled;
transmitting a pattern of acoustic control tones from the portable device to the electronic device using the audio output of the portable device and the microphone of the electronic device;
interpreting the pattern of acoustic control tones in the electronic device using the controller; and
controlling the electronic circuitry in the electronic device in accordance with the pattern of acoustic control tones.

2. The method of claim 1, wherein:
the portable device has a microphone and the electronic device has an audio output; and
transmitting a pattern of acoustic tones from the electronic device to the portable device using the audio output of the electronic device and the microphone of the portable device, thereby facilitating bidirectional acoustic communications between the portable device and the electronic device.

3. The method of claim 1, wherein:
the electronic device is a radio receiver; and
the pattern of acoustic control tones from the portable device to the electronic device is operative to tune the radio to a particular channel frequency.

4. The method of claim 1, wherein:
the portable device has a touch-screen display; and
the portable device includes an application (app) enabling the touch-screen display to function as a control panel for the electronic device.

5. The method of claim 1, wherein:
the portable device has a touch-screen display; and
the portable device includes an application (app) enabling the touch-screen display to provide soft buttons used to control the electronic device.

6. The method of claim 1, wherein:
the portable device has a touch-screen display;
the electronic device is a radio; and
the portable device includes an application (app) enabling the touch-screen display to provide soft buttons used to tune the radio to particular channel frequencies.

7. The method of claim 1, wherein the portable device includes an application (app) operative to deliver targeting advertising to the electronic device.

8. The method of claim 1, wherein the portable device includes an application (app) operative to deliver pay-per-view or pay-to-listen content the electronic device.

9. The method of claim 1, including the steps of:
encrypting the pattern of acoustic tones sent by the portable device; and
decrypting the pattern in the electronic device.

10. The method of claim 1, wherein:
the portable device has a microphone and the electronic device has an audio output; and
acoustically transmitting a serial number or other identifier from the electronic device to the portable device enabling the electronic device to receive specific content from the portable device.

11. The method of claim 1, wherein:
the portable device has a microphone and the electronic device has an audio output; and
acoustically transmitting a serial number or other identifier from the electronic device to the portable device enabling the electronic device to receive pay-per-view or pay-to-listen content.

12. The method of claim 1, wherein the portable device includes an application (app) operative to send an automatic text message or store usage information associated with the electronic device for later retrieval through a phone call or data connection.

13. The method of claim 1, wherein:
the electronic device is a radio; and
the portable device includes an application (app) operative to send an automatic text message or store usage information associated with channel usage data of the radio for later retrieval through a phone call or data connection.

14. The method of claim 1, wherein the acoustic control tones are ultra-sonic, sub-sonic, or audible.

15. The method of claim 1, wherein the pattern of acoustic control tones comprises a burst of FSK, AM or other modulated tones.

16. The method of claim 1, wherein the portable device is a smartphone.

17. The method of claim 1, wherein the portable device is a palmtop, laptop, tablet or other portable computer.

18. A system enabling an electronic device to be controlled with a portable device having a touch-screen display and an audio output, the system comprising:
an electronic device having a microphone, a controller, and electronic circuitry to be controlled;
an application program on the portable device enabling the portable device to generate a pattern of acoustic control tones;
the electronic device being operative to receive and interpret the pattern of acoustic control tones from the portable device; and
wherein the app further enables the touch-screen display of the portable device to act as a control panel to operate the electronic circuitry of the electronic device.

19. The system of claim 18, wherein:
the portable device has a microphone and the electronic device has an audio output; and
the electronic device is operative to transmit a pattern of acoustic tones to the portable device using the audio output of the electronic device and the microphone of the portable device, thereby facilitating bidirectional acoustic communications between the portable device and the electronic device.

20. The system of claim 18, wherein:
the electronic device is a radio receiver; and
the pattern of acoustic control tones from the portable device to the electronic device is operative to tune the radio to a particular channel frequency.

21. The system of claim 18, wherein the touch-screen display of the portable device provides soft buttons used to control the electronic device.

22. The system of claim 18, wherein:
the electronic device is a radio; and
the touch-screen display of the portable device provides soft buttons used to tune the radio to particular channel frequencies.

23. The system of claim 18, wherein the acoustic control tones are ultra-sonic, sub-sonic, or audible.

24. The system of claim 18, wherein the pattern of acoustic control tones comprises a burst of FSK, AM or other modulated tones.

25. The system of claim 18, wherein the portable device is a smartphone.

26. The system of claim 18, wherein the portable device is a palmtop, laptop, tablet or other portable computer.
